(19) United States
(12) Patent Application Publication
(10) Pub. No.: US 2024/0159609 A1
(43) Pub. Date: May 16, 2024

(54) METHOD AND SYSTEM FOR ESTIMATING VEHICLE TRACTION TORQUE USING A DUAL EXTENDED KALMAN FILTER

(71) Applicants: MAGNA INTERNATIONAL INC., Aurora (CA); Wenpeng WEI, East Lansing,, MI (US); Hussein DOURRA, Bloomfield, MI (US); Guoming ZHU, Novi, MI (US)

(72) Inventors: Wenpeng WEI, East Lansing, MI (US); Hussein DOURRA, Bloomfield, MI (US); Guoming ZHU, Novi, MI (US)

(21) Appl. No.: 18/278,531

(22) PCT Filed: Feb. 24, 2022
(86) PCT No.: PCT/US2022/017612

§ 371 Date: Aug. 23, 2023

Related U.S. Application Data
(60) Provisional application No. 63/153,000, filed on Feb. 24, 2021.

(51) Int. Cl. G01L 5/13

(52) U.S. Cl. CPC G01L 5/136; B60W 40/101

(57) ABSTRACT

A method of calculating traction torque of a tire of a vehicle includes calculating a parameter vector using a first extended Kalman filter, calculating a state vector using a second extended Kalman filter, and calculating the longitudinal stiffness as a function of the parameter vector and the state vector. A method for computing traction torque of a vehicle includes computing the longitudinal stiffness of the tire using the first and second extended Kalman filters, and computing the traction torque as a function of the longitudinal stiffness of the tire and a linear speed difference between a tire speed of the tire and a vehicle longitudinal speed.

### CROSS-REFERENCE TO RELATED APPLICATIONS

This PCT International Patent Application claims the benefit of and priority to U.S. Provisional Patent Application Ser. No. 63/153,000, filed Feb. 24, 2021, titled “Method And System For Estimating Vehicle Traction Torque Using A Dual Extended Kalman Filter,” the entire disclosure of which is hereby incorporated by reference in its entirety.

### FIELD

The present disclosure relates generally to a method and system for estimating traction torque of tires in a vehicle.

### BACKGROUND

Physical characteristics of a clutch in a vehicle powertrain are important parameters for modeling and understanding vehicle performance and operation. One such physical characteristic is the traction torque of tires of the vehicle. Improved estimates of the tire traction torque can lead to improvements in vehicle powertrain control.

### SUMMARY

In accordance with an aspect of the disclosure, a method of calculating traction torque of a tire of a vehicle comprises: calculating a parameter vector using a first extended Kalman filter; calculating a state vector using a second extended Kalman filter; and calculating the traction torque as a function of the parameter vector and the state vector.

In accordance with an aspect of the disclosure, a system for calculating traction torque of a tire of a vehicle comprises a processor and a machine-readable storage medium storing instructions that, when executed by the processor, cause the processor to: calculate a parameter vector using a first extended Kalman filter; calculate a state vector using a second extended Kalman filter; and calculate a longitudinal stiffness of the tire as a function of the parameter vector and the state vector; and calculate the traction torque of the tire based on the longitudinal stiffness of the tire.

### BRIEF DESCRIPTION OF THE DRAWINGS

Further details, features and advantages of designs of the invention result from the following description of embodiment examples in reference to the associated drawings.

FIG. 1 shows a side view diagram of a tire in accordance with the present disclosure;

FIG. 2 shows a top-down schematic view of a single-track vehicle model in accordance with the present disclosure;

FIG. 3 shows a block diagram of components in a system in accordance with aspects of the present disclosure;

FIG. 4 shows a schematic block diagram of a dual-extended Kalman filter (DEKF) algorithm in accordance with the present disclosure;

FIG. 5 shows a graph with plots of input signals in a first clutch-overtaken case, over a first common time scale;

FIGS. 6A-6C show graphs with plots of output signals in the first clutch-overtaken case, over the first common time scale;

FIGS. 7A-7B show graphs with plots of output signals in the first clutch-overtaken case, over the first common time scale;

FIG. 8 shows a graph with plots of parameter estimation for longitudinal stiffness and lateral stiffness in the first clutch-overtaken case, over the first common time scale;

FIGS. 9A-9B show graphs with plots of clutch differential speed (Δrpm) and clutch torque in the first clutch-overtaken case, over the first common time scale;

FIGS. 10A-10B show graphs with plots of clutch differential speed (Δrpm) and clutch torque in a second clutch-overtaken second case, over a second common time scale;

FIG. 11 shows a graph with plots of input signals in a first slip clutch case, over a third common time scale;

FIGS. 12A-12C show graphs with plots of output signals in the first slip clutch case, over the third common time scale;

FIG. 13 shows a graph with plots of parameter estimation for longitudinal stiffness and lateral stiffness in the first slip clutch case, over the third common time scale;

FIGS. 14A-14B show graphs with plots of clutch differential speed (Δrpm) and clutch torque in the first slip clutch case, over the third common time scale;

FIGS. 15A-15B show graphs with plots of clutch differential speed (Δrpm) and clutch torque in a second slip clutch case, over a fourth common time scale; and

FIGS. 16A-16B show a flow chart listing steps in a method for estimating longitudinal stiffness to calculate a traction torque of a tire of a vehicle, in accordance with some embodiments of the present disclosure.

### DETAILED DESCRIPTION

Referring to the Figures, wherein like numerals indicate corresponding parts throughout the several views, a system and method for calculating traction torque of a tire of a vehicle is provided.

Vehicle tire traction torque, which is heavily dependent on vehicle speed and tire stiffness, is critical for improving vehicle traction performance. However, due to limitations of existing technology and sensor costs, it may be difficult to accurately measure the vehicle tire traction torque and/or other vehicle variables directly. This disclosure provides a method for estimating the tire traction torque by estimating vehicle speed (vehicle state) and tire stiffness (vehicle parameter) simultaneously based on a few available low-cost measurements, which may be available from any production vehicle. Specifically, the tire and full vehicle dynamics are considered to form a unified traction torque estimation model under various vehicle operational conditions. Estimation of vehicle speed and tire stiffness is formulated into a dual-estimation problem of system states and parameters. A recursive real-time implementable solution for the dual-estimation problem is realized with the help of Dual Extended Kalman Filter (DEKF) algorithm. The effectiveness of the proposed algorithm under different vehicle operation conditions is validated by comparing the estimated results with direct measured ones as well as those from existing estimation approaches. Experimental results show that for a 4-wheel driving vehicle, under clutch overtaken condition, for the best case, the Absolute Mean Square Error improves by around 20 Nm, and the Relative Mean Square Error reduces 12%; and under clutch slip condition, the Absolute Mean Square Error improves by around 40 Nm, and the Relative Mean Square Error is reduced by 6%.

### I. Introduction

It is well known that tires traction torque relates closely to vehicle speed and tire stiffness based on linear and/or nonlinear tire models. This patent disclosure proposes to estimate the vehicle traction torque, based on a linear tire force model, using the vehicle speed and tire stiffness for an internal combustion (IC)-engine powered vehicle under 4-Wheel-Drive (4WD) mode. Note that the proposed methodology can be easily extended to either 2-Wheel-Drive (2WD) vehicles (either front-wheel or rear-wheel drive only) with a simplified vehicle dynamic model or other vehicle platforms, such as battery electric vehicles (BEVs), hybrid electric vehicles (HEVs), and/or autonomous vehicles (AVs), with different propulsion sources.

In fact, tires stiffness changes due to many factors such as tire and ambient temperature, tire surface wearing, vehicle cornering, ground surface condition (e.g., dry or wet), and so on. Thus, online or real-time estimation of the tire stiffness can provide improved estimation of traction torque.

Note that vehicle speed is identified in this disclosure as a system state, whereas the tire stiffness is identified as a system parameter (see Section II for details), and the problem of estimating traction force can be transformed into a dual estimation problem of system states and parameters, for which the Dual Extended Kalman Filter (DEKF) algorithm is a good candidate. The DEKF algorithm was commonly used for estimating the State of Charge (SOC) and State of Health (SOH) in Battery Management System (BMS) of a BEV or HEV.

Of course, there is also application of the DEKF algorithm to estimate vehicle states and parameters. Vehicle states (such as vehicle speed, yaw rate, tire forces, etc.) and vehicle parameters (such as tire-ground friction coefficient, vehicle mass, and so on) have been estimated concurrently based on full vehicle dynamics. However, a major drawback of some previous work is that only simulation study have been performed and there are no reported experimental validation results.

In this disclosure, the full vehicle dynamic model is integrated with the tire dynamic model to formulate a traction torque estimation model. The vehicle speed (tire stiffness) is identified as one of vehicle states (parameters), and then the DEKF algorithm is applied to make the dual estimation possible. More importantly, the torque estimation results are compared with the directly measured ones from a testing vehicle to confirm its effectiveness.

An aspect of the present disclosure is the application of Dual Extended Kalman Filter algorithm to simultaneously estimate tire stiffness and vehicle longitudinal speed under different driving conditions, and accurate vehicle traction torque estimation is validated experimentally.

Section II establishes the traction torque estimation model based on tire and vehicle dynamics of a 4WD vehicle. Section III transforms the system model into a general nonlinear model for the DEKF algorithm. In Section IV, the recursive solution of DEKF algorithm is briefly summarized and in Section V, the effectiveness of proposed algorithm is validated using experimental data under different driving conditions. The last section draws some conclusions.

### II. Traction Torque Estimation Model

This patent disclosure aims to estimate vehicle tire traction torques. Note that the engine torque is assumed to be available through estimation and once the front tire traction torque is obtained, the rear tire traction torque can be easily calculated. Therefore, this patent disclosure only shows the torque estimation result of the front propeller shaft in the rest of this patent disclosure.

### A. Tire Dynamics Model

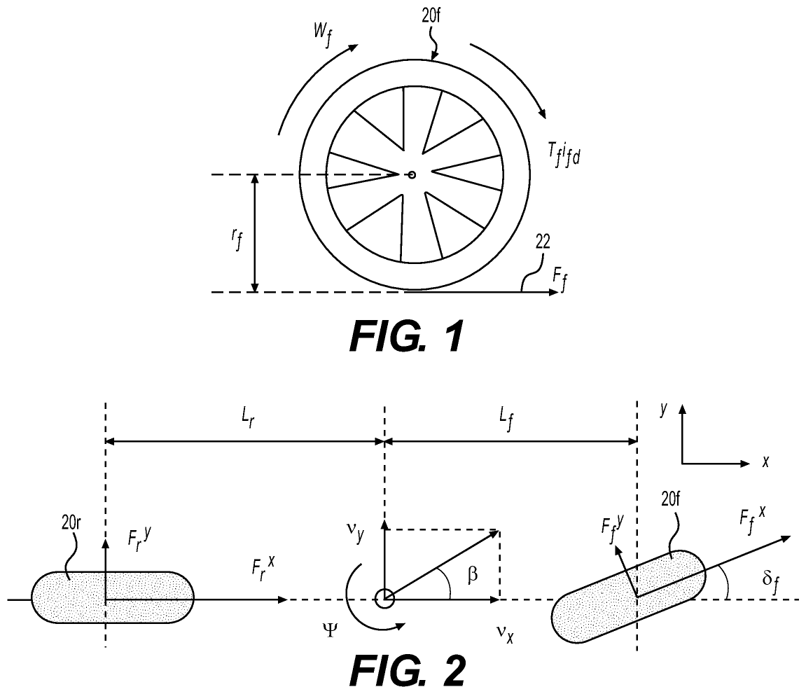

The front propeller shaft torque drives the front tires through the front differential and axles. The forces applied to a front tire 20f are shown in FIG. 1. Specifically, FIG. 1 shows a side view diagram of a front tire 20f, illustrating forces acting upon the front tire 20f as it rolls along a ground surface 22. Similar or identical forces may also act upon a rear tire 20r. The tire dynamics described below provide a mathematical relationship between front propeller shaft torque and front tires.

J_{f}\dot{w}_{f}=T_{f}i_{fd}−F_{fc}^{x}r_{f} (1)

where J_{f}(kg·m²) is front tire inertia; T_{f}(N·m) is front propeller shaft torque; and i_{fd} is front differential ratio. The longitudinal force F_{fc}^{x}(N) and effective tire radius r_{f}(m) are described in the next subsection.

Accurate traction torque requires accurate combination of longitudinal stiffness Cᵢ^{x} and linear speed difference between tire speed and vehicle longitudinal speed rᵢwᵢ−vₓ. Note that longitudinal stiffness Cᵢ^{x} usually changes as vehicle driving condition varies, and accurate vehicle longitudinal speed vx is not available due to the lack of production ready sensor. As a result, both of them need to be estimated in the real-time based on a vehicle dynamic model decoupled from the traction torque.

### B. 4WD Vehicle Dynamic Model

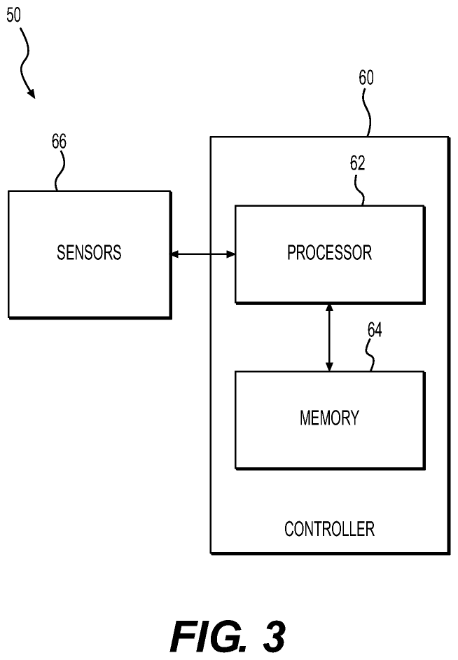

The 4WD vehicle dynamics is described by a single-track (bicycle) model as shown in FIG. 2, where two front (or rear) tires are lumped into one. In other words, FIG. 2 may represent a 2-wheel simplification of a 4-wheeled vehicle, wherein each of the two front tires 20f are subjected to substantially equivalent forces such that they can be represented by a single front tire 20f, and wherein each of the two rear tires are subjected to substantially equivalent forces such that they can be represented by a single rear tire 20r. FIG. 2 shows a top-down schematic view of a single-track vehicle model, including a single rear tire 20r following behind a single front tire 20f. However, the principles of the present disclosure may be applied to vehicles having any number of wheels and tires. For example, the principles of the present disclosure may be applied to a vehicle having one, two, three, four, or five or more wheels and tires.

Several assumptions are made to simplify estimation model. 1) The steering wheel only turns front tires not rear ones; 2) Left and right tires have the same stiffness; 3) Drag forces due to air, wind and rolling resistance, are ignored; 4) Vehicle operates under normal driving condition where the tire longitudinal force-slip ratio and lateral forces-slip angle relationship are linear.

Considering vehicle longitudinal (x), lateral (y) and yaw (v) direction motions using Newton's Second Law, the following dynamic equations can be easily obtained.)

m(\dot{v}ₓ−v_{y}\dot{ψ})=F_{f}^{x}cosδ_{f}Fᵣ^{x}−F_{f}^{y}sinδ_{f} (2)

m(\dot{v}_{y}+vₓ\dot{ψ})=F_{f}^{x}sinϵ_{f}+F_{f}^{y}cosδ_{f}+Fᵣ^{y} (3)

Iψ̋=(F_{f}^{x}sinδ_{f}+F_{f}^{y}cosδ_{f})L_{f}−Fᵣ^{y}Lᵣ (4)

where vₓ (m/s) denotes longitudinal speed; v_{y} (m/s) represents lateral velocity; \dot{ψ} (rad/s) is yaw rate; m (kg) is vehicle mass; δ_{f}(°) is the steering angle at front tire; I (kg·m²) is yaw moment of inertia; L_{f} (m) is distance from center of gravity to front axle; Lᵣ (m) is distance from center of gravity to rear axle; Fᵢ^{x} (N) is longitudinal force with i denotes ‘f’ or ‘r’ representing front or rear tire; and Fᵢ^{y} (N) is lateral force.

Typically, the steering wheel angle (δ) can be measured, instead of steering angle at front tire (δ_{f}). However, they are related by the following equation assuming a linear relationship when the steering angle is small.

$${δ}_{f} = \frac{δ}{{r}_{s}} \qquad ( 5 )$$

where rₛ denotes the steering ratio from steering wheel to front tires.

Under assumptions (1) and (4), the tire forces under vehicle acceleration condition can be calculated by the following equations, respectively.

$${F}_{i}^{x} \approx {C}_{i}^{x} \frac{{r}_{i} {w}_{i} - {v}_{x}}{{r}_{i} {w}_{i}} \qquad ( 6 )$$

$${F}_{f}^{y} \approx {C}_{f}^{y} ( {δ}_{f} - \frac{{v}_{y} + {L}_{f} \dot{ψ}}{{v}_{x}} ) \qquad ( 7 )$$

$${F}_{r}^{y} \approx {C}_{r}^{y} \frac{{L}_{r} \dot{ψ} - {v}_{y}}{{v}_{x}} \qquad ( 8 )$$

where Cᵢ^{x} (N) is the corresponding longitudinal stiffness; Cᵢ^{y} (N/rad) is the corresponding lateral stiffness; wᵢ (rad/s) is the corresponding tire rotational speed; rᵢ (m) is the corresponding effective tire radius which is related to tire pressure and vehicle acceleration by the following equation (9), which is described in the article “Transfer case clutch torque modeling and validation under slip and overtaken conditions,” ASME Journal of Dynamic System, Measurement and Control, 2020.

$${r}_{f} = \{ \begin{matrix}{r}_{wf} - \frac{{x}_{f}}{3} - {n}_{1} {a}_{x}^{2} & accelerating \\ {r}_{wf} - \frac{{z}_{f}}{3} & coasting down\end{matrix} \qquad ( 9 )$$

$${r}_{r} = {r}_{wr} - \frac{{z}_{r}}{3}$$

where r_{wi} is the undeformed tire radius; zᵢ (m) is the tire deformation displacement; aₓ (m/s²) is the longitudinal acceleration; and n₁ is a compensation coefficient.

Remember that the clutch may operate under either overtaken (locked) or slip condition during vehicle acceleration. The above derivation works perfectly under clutch overtaken condition. While under clutch slip condition, the front tire longitudinal force F_{f}^{x} is replaced by F_{fc}^{x} with clutch slip-speed compensation.

$${F}_{fc}^{x} \approx {C}_{f}^{x} \frac{( {r}_{f} {w}_{f} + Δ {v}_{f} ) - {v}_{x}}{( {r}_{f} {w}_{f} + Δ {v}_{f} )} \qquad ( 10 )$$

$$Δ {v}_{f} = \frac{1}{2} \frac{Δ rpm}{{i}_{fd}} {r}_{f}$$

$$Δ rpm = {w}_{r} {i}_{r d} - {w}_{f} {i}_{fd}$$

where Δv_{f} (m/s) is linear slip-speed at front tire and Δrpm is clutch slip-speed. Note that this equation describes a general clutch operating condition, making the overtaken condition a special case with Δrpm≤Δ₀, considering measurement noise. Δ₀(≥0) is a calibrated threshold, depending on the measurement precision, that determines clutch overtaken or slip condition. In this disclosure, Δ₀ is selected to be 2 rpm.

The goal is to estimate the driving-condition-dependent longitudinal (Cᵢ^{x}) and lateral (Cᵢ^{y}) stiffness in the absence of vehicle longitudinal and lateral speed measurements. However, for the estimation algorithm to work properly, several necessary measurements from vehicle are needed, and they are yaw rate, longitudinal and lateral accelerations. Note that these measurements are easily available through low cost IMU sensors (e.g., acceleration and rate gyro sensors). The longitudinal and lateral accelerations are related to vehicle forces as shown below.

$${a}_{x} = \frac{1}{m} ( {F}_{f}^{x} cos {δ}_{f} + {F}_{r}^{x} - {F}_{f}^{y} sin {δ}_{f} ) \qquad ( 11 )$$

$${a}_{y} = \frac{1}{m} ( {F}_{f}^{x} sin {δ}_{f} + {F}_{f}^{y} cos {δ}_{f} + {F}_{r}^{y} ) \qquad ( 12 )$$

where aₓ (m/s²) is vehicle longitudinal acceleration and ay (m/s²) is lateral acceleration.

### III. System Transformation

Choose system state vector as xₛ=[vₓ, v_{y}, \dot{ψ}]^{T}, system parameter vector as xₚ=[C_{f}^{x}, Cᵣ^{x}, C_{f}^{y}, Cᵣ^{y}]^{T}, system input vector as u=[w_{f}, wᵣ, δ, r_{f}, rᵣ]^{T}, and system output as y=[aₓ, a_{y}, \dot{ψ}]^{T}. To proceed with the DEKF algorithm, the system is discretized using Euler Forward Approximation with a sample period of Ts as below.

$$\dot{x} \approx \frac{{x}_{k + 1} - {x}_{k}}{{T}_{s}} \qquad ( 13 )$$

Considering also the additive processing noise (wₖ) and measurement noise (vₖ), the 4WD vehicle dynamic model can be transformed into a more general nonlinear form as in equation (14), below.

xₖ₊₁=f(xₛₖ, xₚₖ, uₖ)+wₖ_{_{|}}

[symbol]

ₖ=h(xₛₖ, xₚₖ, uₖ)+vₖ (14)

Note that wₖ and vₖ are assumed to be mutually independent and zero-mean white noises satisfying equation (15):

```
  E(wₖ) = 0; E(wₖwₖ^{T}) = R_{w} E(wₖ_{₁} wₖ_{₂}^{T}) = 0
  E(vₖ) = 0; E(vₖvₖ^{T}) = Rᵥ E(vₖ_{₁}vₖ_{₂}^{T}) = 0
E(wₖ_{₁}vₖ_{₂}) = 0 k₁ ≠ k₂
```

where E(⋅) denotes expectation operation of the corresponding term; R_{w} and Rᵥ are the covariance matrices of wₖ and vₖ, respectively; and k₁ and k₂ are different step indexes.

To achieve the goal of traction torque estimation, the front tire longitudinal stiffness (C_{f}^{x}) and vehicle longitudinal speed (vₓ) need to be estimated first. Note that front tire longitudinal stiffness (C_{f}^{x}) appears to be system parameter while vehicle longitudinal speed (vₓ) appears to be system state, which means that the dual estimation of system states and parameters problem is encountered. One methodology for solving this kind of problem is the DEKF approach.

Another system is established to describe the ‘dynamics’ of system parameter vector as below:

xₚ₍ₖ₊₁₎=xₚₖ+pₖ

dₖ=h(xₛₖ, xₚₖ, uₖ)+eₖ (16)

where pₖ mimics parameter processing noise due to potential vehicle driving condition change; and eₖ is output estimation error noise. pₖ and eₖ are assumed to have the same properties as wₖ and vₖ, and their covariance matrices are denoted by Rₚ and Rₑ, respectively.

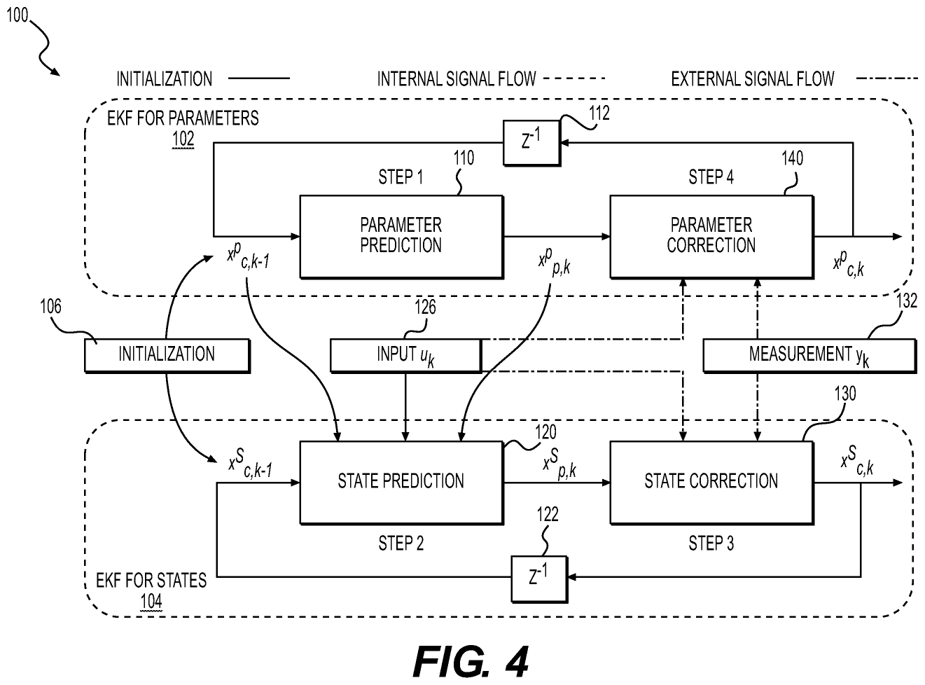

FIG. 3 shows a block diagram of components in a system 50 in accordance with aspects of the present disclosure. The system 50 may be, for example, a powertrain control system of a motor vehicle. The system 50 includes a controller 60, such as an electronic control unit (ECU) having a processor 62 in functional communication with a machine-readable storage memory 64. The processor 62 may include, for example, one or more microprocessors or microcontrollers and may include one or more processing cores. The machine-readable storage memory 64 may contain data and program instructions for execution by the processor 62 to cause the processor 62 to perform one or more functions of the present disclosure. The processor 62 may be in functional communication with one or more sensors 66. The sensors 66 may be directly connected to the processor 62. Alternatively, data from the sensors 66 may be communicated to the processor 62 from one or more remote controllers (not shown).

### IV. Dual Extended Kalman Filter Algorithm

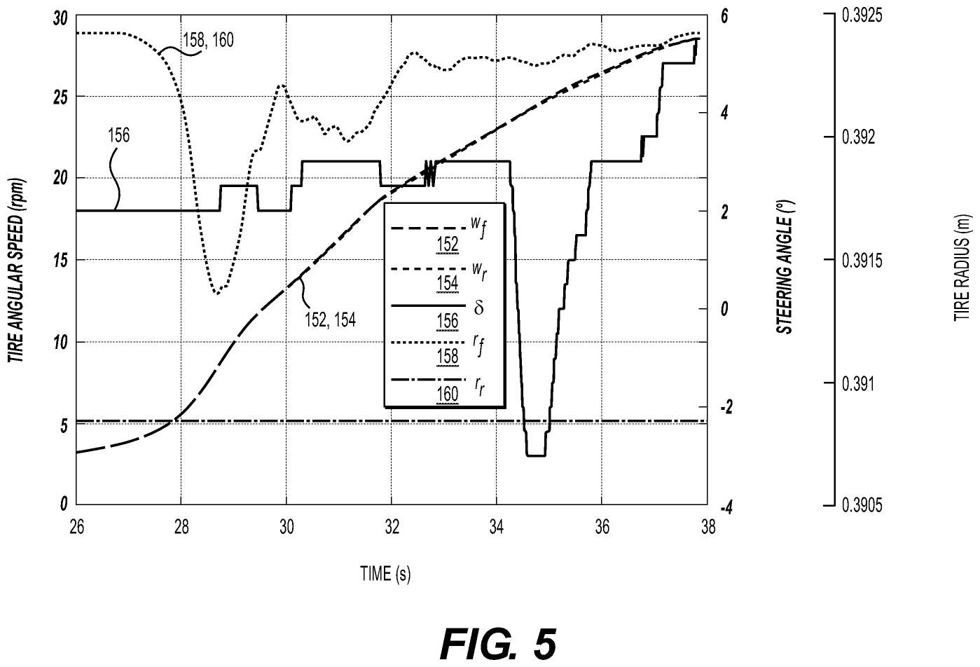

With state-space system representation defined by equation (14) and parameter system defined by equation (16), the DEKF algorithm can be utilized to realize dual estimation of system states and parameters. FIG. 4 shows a schematic block diagram of a dual-extended Kalman filter (DEKF) algorithm 100 in accordance with the present disclosure. One or more steps of the DEKF algorithm 100 may be performed by the processor 62. The DEKF algorithm 100 includes a first extended Kalman filter (EKF) 102 for estimating parameters. This first EKF 102 may be called parameter estimator 102. One or more components of the first EKF 102 may be performed by the processor 62. In some embodiments, the entire first extended Kalman filter (EKF) 102 is provided as instructions stored in the memory 64 and executed by the processor 62. The DEKF algorithm 100 includes a second extended Kalman filter (EKF) 104 for estimating states. This second EKF 104 may be called state estimator 104. One or more components of the second EKF 104 may be performed by the processor 62. In some embodiments, the entire second EKF 104 is provided as instructions stored in the memory 64 and executed by the processor 62. The block diagram of FIG. 4 shows the signal flow between the state and parameter estimators 104, 102. For each estimation step, the detailed state and parameter estimation methods are summarized and described in the subsequent steps.
Step 0: Initialization—Let:

$${x}_{0}^{s} = {x}_{s 0} , {x}_{0}^{p} = {x}_{p 0} , {P}_{0}^{s} = {P}_{s 0} , {P}_{0}^{p} = {P}_{p 0} \qquad ( 17 )$$

$${{K}_{0}^{s} = {K}_{s 0} [ \frac{dh}{{dx}_{p}} ] \vert}_{k = 0} = {H}_{xp 0}$$

where x₀^{s} means initial state; x₀^{p} is initial parameter; P₀^{s} is initial state covariance matrix; P₀^{p} is initial parameter covariance matrix; K₀^{s} is initial state correction gain;

$${[ \frac{d h}{d {x}_{p}} ] \vert}_{k = 0}$$

is the initial output derivative with respect to parameter vector. DEKF method 100 includes an initialization block 106 performing the initialization and to provide the initial state x₀^{s} and the initial parameter x₀^{p}.

For the following steps, the notation rules are: superscript s corresponds to the value associated with state; superscript p corresponds to the value associated with parameter; subscript p means prediction step; subscript c means correction step; P means the associated covariance matrix; K means associated gain matrix; k and k−1 represents time steps.
Step 1: Predicting the parameter vector—the parameter vector is predicted by:

$${x}_{p , k}^{p} = {x}_{c , k - 1}^{p} \qquad ( 18 )$$

$${P}_{p , k}^{p} = {P}_{c , k - 1}^{p} + {R}_{p} , {R}_{p} = ( \frac{1}{λ} - 1 ) {P}_{p , k - 1}^{p}$$

where Rₚ is the parameter prediction covariance matrix. Rₚ is selected as the last equation above with forgetting factor λ∈(0, 1], indicating exponentially decaying weighting on past data. Parameter prediction block 110 of the parameter estimator 102 may perform step 1. The parameter prediction block 110 may take the initial parameter value x₀^{p} from the initialization block 106 as an initial input. Subsequently, the parameter prediction block 110 may take, as an input, a time-delayed parameter value x_{c,k-1}^{p} from a first time delay block 112. The first time delay block 112 may generate the time-delayed parameter value x_{c,k-1}^{p} by holding a corrected parameter value x_{c,k}^{p} for some predetermined period of time, after which the corrected parameter value x_{c,k}^{p} is passed to the parameter prediction block 110 as the time-delayed parameter value x_{c,k-1}^{p}. The parameter prediction block 110 may use the initial parameter value x₀^{p} and/or the time-delayed parameter value x_{c,k-1}^{p} to calculate a predicted parameter value x_{p,k}^{p}.
Step 2: Predicting the state vector—the state vector is predicted by:

$${x}_{p , k}^{s} = f ( {x}_{c , k - 1}^{s} , {u}_{k} , {x}_{p , k}^{p} ) \qquad ( 19 )$$

$${P}_{p , k}^{s} = {F}_{k - 1} {P}_{c , k - 1}^{s} {F}_{k - 1}^{T} + {R}_{w}$$

$${{F}_{k - 1} = [ \frac{df ( {x}_{sk} , {u}_{k} , {x}_{p , k}^{p} )}{{dx}_{sk}} ] \vert}_{{x}_{sk} = {x}_{c , k - 1}^{s}}$$

where Fₖ₋₁ is the Jacobian matrix of state equation f(⋅) with respect to state vector xₛ evaluated at x_{c,k-1}^{s} and R_{w} is state process noise covariance matrix. State prediction block 120 of the state estimator 104 may perform step 2. The state prediction block 120 may take the initial state value x₀^{s} from the initialization block 106 as an initial input. Subsequently, the state prediction block 120 may take, as an input, a time-delayed state value x_{c,k-1}^{s} from a second time delay block 122. The second time delay block 122 may generate the time-delayed state value x_{c,k-1}^{s} by holding a corrected state value x_{c,k}^{s} for some predetermined period of time, after which the corrected state value x_{c,k}^{s} is passed to the state prediction block 120 as the time-delayed state x_{c,k-1}^{s}. The state prediction block 120 may use the initial state value x₀^{s} and/or the time-delayed state value x_{c,k-1}^{s} to calculate a predicted state value x_{p,k}^{s}. The state prediction block 120 may also take, as inputs, a system input vector uₖ from an input block 126 and the predicted parameter value x_{p,k}^{p} from the parameter prediction block 110.
Step 3: Correcting the state vector—The state vector is corrected by:

$${K}_{k}^{s} = {{{P}_{p , k}^{s} ( {H}_{k}^{s} )}^{T} [ {H}_{k}^{s} {{P}_{p , k}^{s} ( {H}_{k}^{s} )}^{T} + {R}_{v} ]}^{- 1} \qquad ( 20 )$$

$${x}_{c , k}^{s} = {x}_{p , k}^{s} + {K}_{k}^{s} ( {y}_{k} - {\hat{y}}_{k} )$$

$${P}_{c , k}^{s} = ( I - {K}_{k}^{s} {H}_{k}^{s} ) {P}_{p , k}^{s}$$

$${{H}_{k}^{s} = [ \frac{dh ( {x}_{sk} , {u}_{k} , {x}_{p , k}^{p} )}{{dx}_{sk}} ] \vert}_{{x}_{s , k} = {x}_{p , k}^{s}}$$

$${\hat{y}}_{k} = h ( {x}_{p , k}^{s} , {u}_{k} , {x}_{p , k}^{p} )$$

where Rᵥ is the output measurement noise covariance matrix; Hₖ^{s} is the Jacobian matrix of output equation h(⋅) with respect to state vector xₛ evaluated at x_{p,k}^{s}; and ŷ is the estimated output with current available inputs, state vector and parameter vector. State correction block 130 of the state estimator 104 may perform step 3. The state correction block 130 may take, as inputs, the predicted state value x_{p,k}^{s} from the state prediction block 120, the input value uₖ from the input block 126, and a system measurement vector yₖ from a measurement block 132. The state correction block 130 may use the predicted state value x_{p,k}^{s} to calculate the corrected state value x_{c,k}^{s}.
Step 4: Correcting the parameter vector—The parameter vector is corrected by:

$${K}_{k}^{p} = {{{P}_{p , k}^{p} ( {H}_{k}^{p} )}^{T} [ {H}_{k}^{p} {{P}_{p , k}^{p} ( {H}_{k}^{p} )}^{T} + {R}_{e} ]}^{- 1} \qquad ( 21 )$$

$${x}_{c , k}^{p} = {x}_{p , k}^{p} + {K}_{k}^{p} ( {y}_{k} - {\hat{y}}_{k} )$$

$${P}_{c , k}^{p} = ( I - {K}_{k}^{p} {H}_{k}^{p} ) {P}_{p , k}^{p}$$

$${{H}_{k}^{p} = [ \frac{dh ( {x}_{p , k}^{s} , {u}_{k} , {x}_{p k} )}{{dx}_{p k}} ] \vert}_{{x}_{p k} = {x}_{p , k}^{p}}$$

where Rₑ is the parameter estimation output covariance matrix; and Hₖ^{p} is the Jacobian matrix of output equation h(⋅) with respect to parameter vector xₚ evaluated at x_{p,k}^{p}. Note that the calculation of Hₖ^{p} needs some further manipulation since x_{p,k}^{s} is also a function of x_{p,k}^{p} according to equation (19). Therefore, according to derivative chain law, it can be first expanded to:

$$\frac{dh ( {x}_{p , k}^{s} , {u}_{k} , {x}_{p k} )}{{dx}_{p k}} = \frac{\partial h ( {x}_{p , k}^{s} , {u}_{k} , {x}_{p k} )}{\partial {x}_{p k}} + \frac{\partial h ( {x}_{p , k}^{s} , {u}_{k} , {x}_{p k} )}{\partial {x}_{p , k}^{s}} \frac{{dx}_{p , k}^{s}}{{dx}_{p , k}^{p}} \qquad ( 22 )$$

Derivative of x_{p,k}^{s} with respect to x_{p,k}^{p} can then further be expanded to:

$$\frac{{dx}_{p , k}^{s}}{{dx}_{p . k}^{p}} = \frac{\partial f ( {x}_{c , k - 1}^{s} , {u}_{k} , {x}_{p k} )}{\partial {x}_{p k}} + \frac{\partial f ( {x}_{c , k - 1}^{s} , {u}_{k} , {x}_{p k} )}{\partial {x}_{c , k - 1}^{s}} \frac{{dx}_{c , k - 1}^{s}}{{dx}_{p , k}^{p}} \qquad ( 23 )$$

$$\frac{{dx}_{c , k - 1}^{s}}{{dx}_{p , k}^{p}} = \frac{{dx}_{p , k - 1}^{s}}{{dx}_{p , k}^{p}} - {K}_{k - 1}^{s} \frac{dh ( {x}_{p , k - 1}^{s} , {u}_{k - 1} , {x}_{p ( k - 1 )} )}{{dx}_{p ( k - 1 )}}$$

To this point, Hₖ^{p} can be obtained recursively by equations (22) and (23), and the entire DEKF algorithm completes. Parameter correction block 140 of the parameter estimator 102 may perform step 4. The parameter correction block 140 may take, as inputs, the predicted parameter value x_{p,k}^{p} from the parameter prediction block 110, the system input vector uₖ from the input block 126, and the system measurement vector yₖ from the measurement block 132. The parameter correction block 140 may use the predicted parameter value x_{p,k}^{p} to calculate the corrected parameter value x_{c,k}^{p}.

### V. Experimental Validation

In this section, the DEKF algorithm is validated with multiple experiment data under different vehicle operation conditions. The algorithm is implemented in Matlab/Simulink software.

### A. Algorithm Initialization

Vector xₛ₀=[0.01, 0.01, 0.01]^{T} represents the initial condition of state vector, namely longitudinal speed, lateral speed and yaw rate. Since the states may appear in the denominator position of the system, to avoid the numerical issue (dividing by zero), they are replaced by a small number instead of 0. Vector xₚ₀=[2.8e⁵, 2.5e⁵, 800, 800]^{T} represents the initial condition of parameter vector. Matrix Pₛ₀=eye(ns) represents the initial value of state covariance matrix, where eye is the identity matrix and ns is the number of states, denoting the matrix dimension. Matrix Pₚ₀=eye(np) represents the initial value of parameter covariance matrix, where np is the number of parameters. Matrix Kₛ₀=zeros(ns) represents the initial value of state correction gain matrix, with zeros as a matrix with all 0 elements. Matrix Hₓₚ₀=0.01*eye(ns, np) is selected in the same way as state vector does. Matrix R_{w}=diag[100, 100, 100] represents the processing noise covariance matrix, where diag means diagonal matrix. Rᵥ=diag[1e⁻², 1e⁻², 1e⁻²] is the measurement noise covariance matrix. Note that the processing noise is usually 10 times larger than the measurement noise. Matrix Rₑ=diag[10, 10, 1] denotes the initial values of parameter estimation noise covariance matrix.

Only vehicle accelerating period is considered since the 4WD mode will be active under this operational condition. In the following sections, results of vehicle operating under overtaken clutch condition is first validated, and followed by the slip clutch case.

### B. Overtaken Clutch Torque Estimation Validation

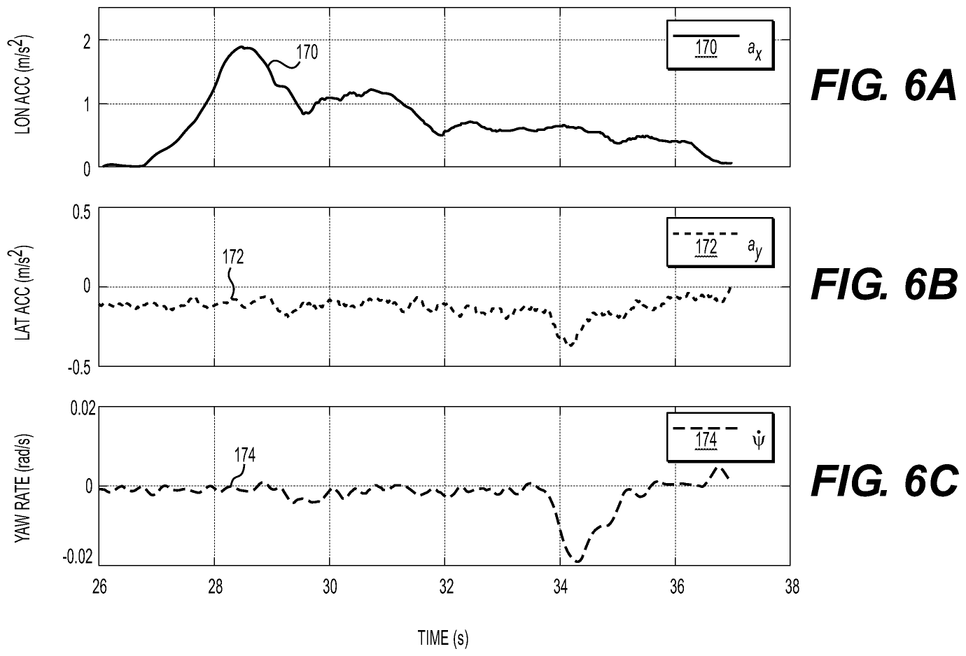

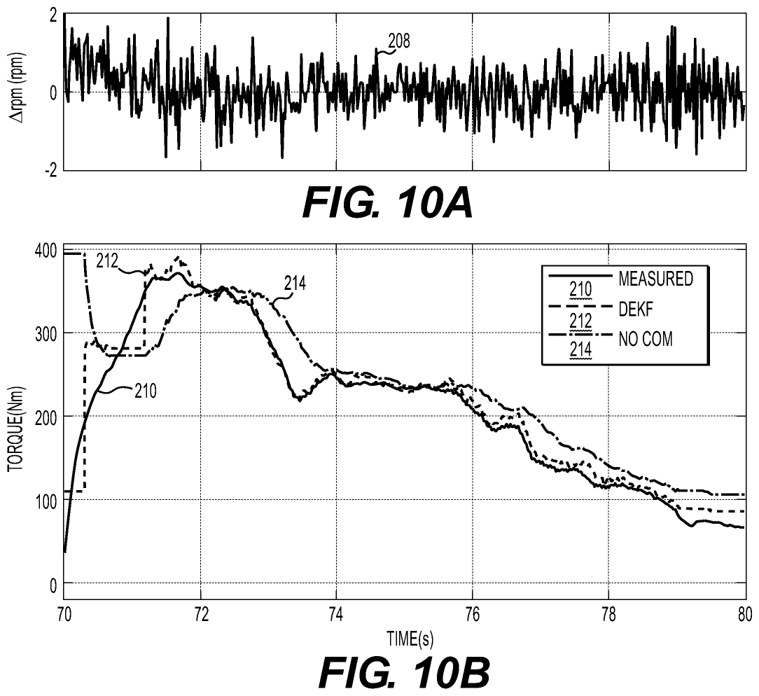

FIG. 5 shows the input signals in a first clutch-overtaken case. The rotational speed of front and rear tires, shown in plots 152 and 154, respectively, from wheel speed sensors are close enough, and by equation (10), the clutch slip speed Δrpm is calculated and shown on FIG. 9A, which confirms that the clutch is overtaken. For the steering wheel angle shown in plot 156, it is required to be small so that the longitudinal and lateral force work in the linear region. The tire radius for front and rear tires are shown in plots 158, 160, respectively. The front tire incorporated the time-varying acceleration effect.

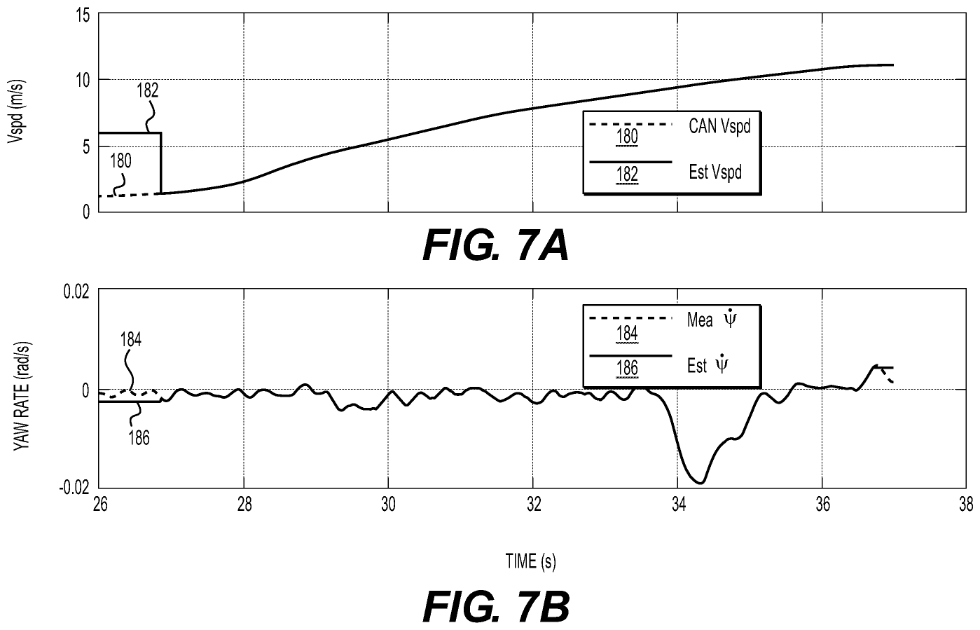

FIGS. 6A-6C show the measured output signals from an accelerometer mounted on the vehicle. The positive longitudinal acceleration indicates that the vehicle is accelerating. Due to the non-zero steering angle applied, the lateral acceleration and yaw rate exist. Plot 170 of FIG. 6A shows longitudinal acceleration ax of the vehicle. Plot 172 of FIG. 6B shows lateral acceleration ay of the vehicle. Plot 174 of FIG. 6C shows yaw rate ti) of the vehicle.

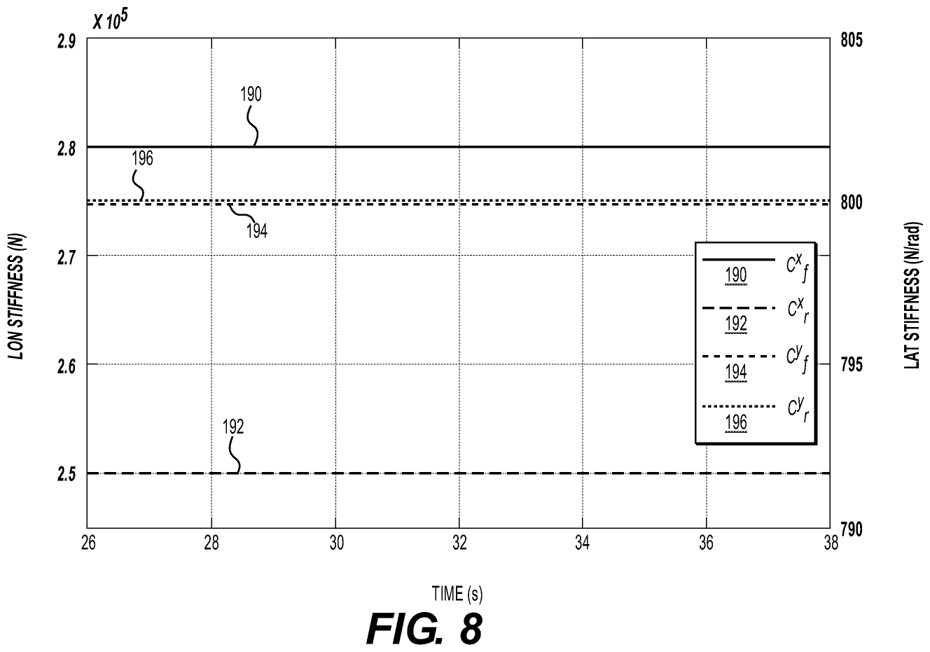

FIGS. 7A-7B show the corresponding system state estimation results from the DEKF algorithm. Specifically, plot 180 of FIGS. 7A-7BA shows a measured vehicle speed, and plot 182 of FIGS. 7A-7BA shows the vehicle speed estimated by the DEKF algorithm. Plot 184 of FIGS. 7A-7BB shows measured yaw rate \dot{ψ} and plot 186 of FIGS. 7A-7BB shows an estimated yaw rate \dot{ψ}, which is estimated by the DEKF algorithm. Note that since there is no measured lateral speed available and this value is not related to the subsequent traction torque estimation, the comparison is not shown here. The longitudinal speed and yaw rate estimations show that they are corresponding to the measured one pretty well.

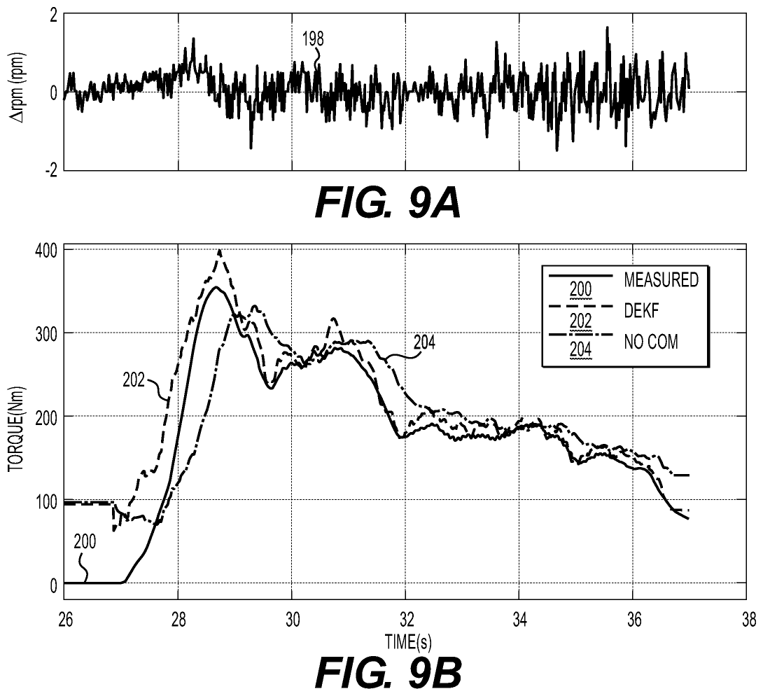

FIG. 8 shows the parameters estimation results from the DEKF algorithm. The initial values of parameters are set to pre-calibrated values: [C_{f}^{x}, Cᵣ^{x}, C_{f}^{y}, Cᵣ^{xy}]=[2.8e⁵, 2.5e⁵, 800, 800]. Plot 190 shows the front tire longitudinal stiffness C_{f}^{x}, plot 192 shows the rear tire longitudinal stiffness Cᵣ^{x}, plot 194 shows the front tire lateral stiffness C_{f}^{y}, and plot 196 shows the rear tire lateral stiffness Cᵣ^{y}. Under this acceleration, it can be seen that the estimated stiffness is quite stable, this is because that the vehicle runs on a similar testing road condition in a straight line. And since there are no direct measurements available, no comparison can be shown. However, an indirect validation can be made through the traction torque comparison since according to equation (1), the front tire longitudinal stiffness C_{f}^{x} determines the accuracy of front traction torque T_{f}. For validation purpose, the front traction torque T_{f} is measured at the front propeller shaft using a torque sensor.

In FIGS. 9A-9B, front traction torque validation results are presented using several approaches under the first overtaken clutch case. Plot 198 of FIG. 9A shows clutch differential speed (Δrpm). Plot 200 of FIG. 9B, with legend ‘Measured’ is obtained from the torque sensor measurement. Plot 202 of FIG. 9B, with legend ‘DEKF’ is from the proposed DEKF algorithm with clutch slip-speed compensation using equation (10). Plot 204 of FIG. 9B with legend ‘No Com’ means an ‘ASME’ approach without clutch slip-speed compensation. The ‘ASME’ approach may include an algorithm presented in the article: “Transfer case clutch torque modeling and validation under slip and overtaken conditions,” ASME Journal of Dynamic System, Measurement and Control, 2020 with slip-speed compensation, which is based on a pure vehicle dynamics model. Under clutch overtaken condition, the ‘ASME’ approach is the same as ‘No Com’ approach since in this case the clutch slip speed equals to 0. It can also be observed that traction torque obtained from both the DEKF and the “No Com” approaches are able to track the measured torque quite well. The numerical error analysis is performed in the later section along with other data obtained from overtaken clutch and slip clutch operating conditions.

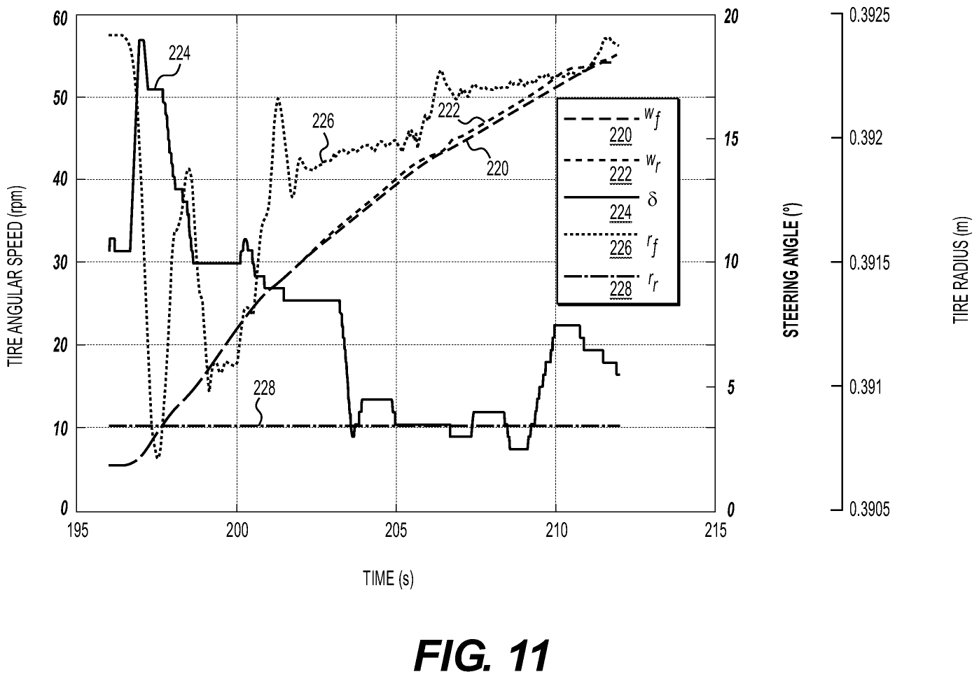

FIGS. 10A-10B show validation results of the second overtaken clutch case traction torque estimation, where the testing conditions (small steering wheel angle, vehicle in acceleration) are similar to that of the first overtaken clutch case. For this condition, only clutch slip-speed and torque estimation results are shown. Again, the clutch slip-speed confirms the overtaken condition and the traction torque estimation results from different estimation approaches are close to the measured torque. Plot 208 of FIG. 10A shows clutch differential speed (Δrpm). Plot 210 of FIG. 10B, with legend ‘Measured’ is obtained from the torque sensor measurement. Plot 212 of FIG. 10B, with legend ‘DEKF’ is from the proposed DEKF algorithm with clutch slip-speed compensation using equation (10). Plot 214 of FIG. 10B with legend ‘No Com’ means the ‘ASME’ approach without clutch slip-speed compensation. The ‘ASME’ approach may include an algorithm presented in the article “Transfer case clutch torque modeling and validation under slip and overtaken conditions,” ASME Journal of Dynamic System, Measurement and Control, 2020 with slip-speed compensation, which is based on a pure vehicle dynamics model.

### C. Slip Clutch Torque Estimation Validation

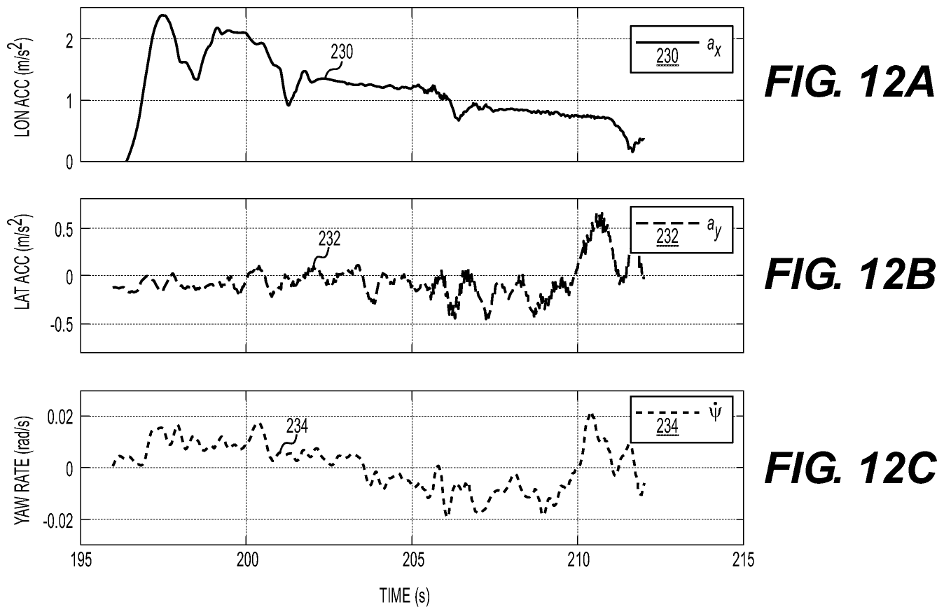

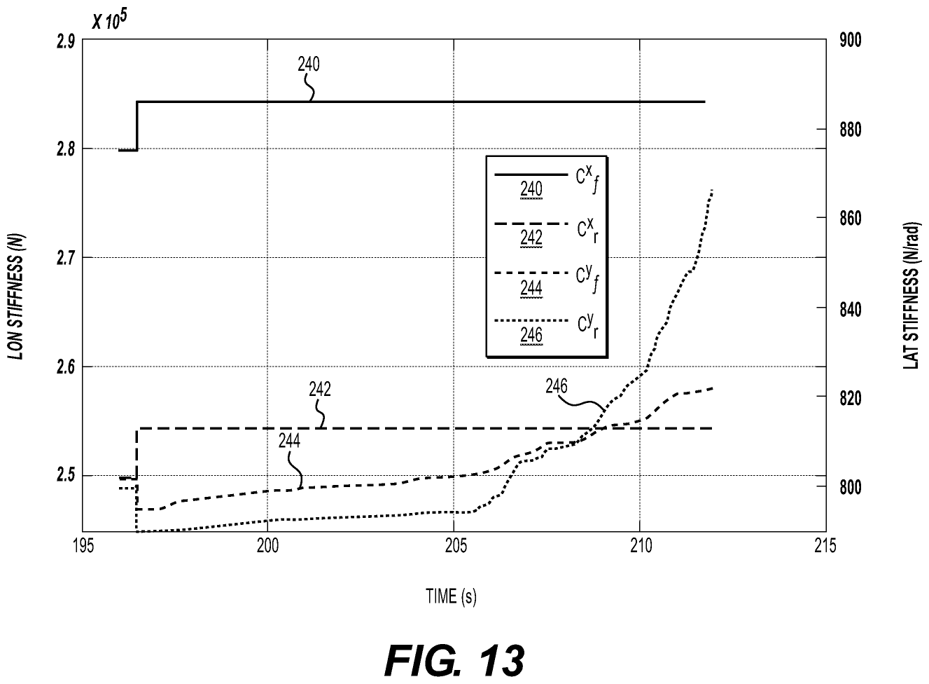

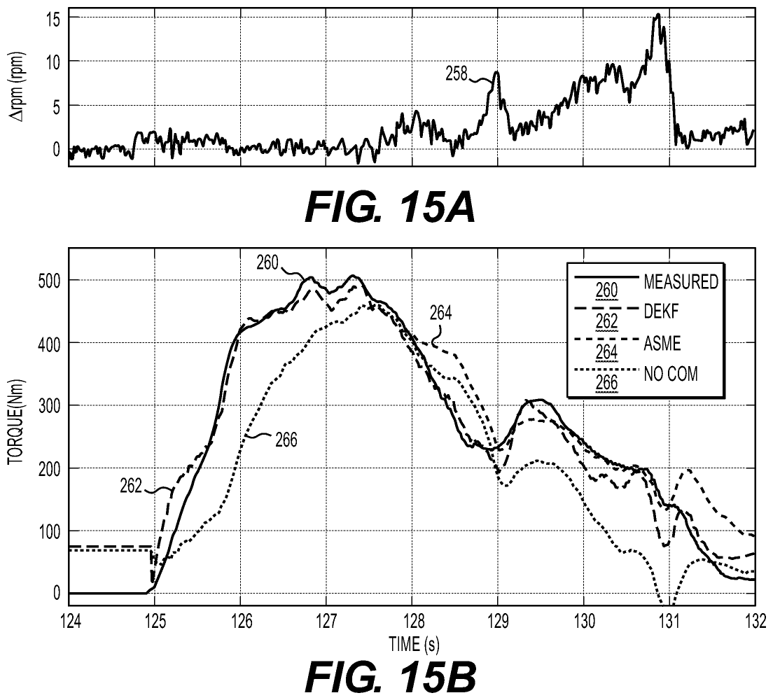

In this section, the DEKF algorithm is validated under clutch slip condition. FIG. 11 shows the input signals. Specifically, plot 220 shows front tire angular velocity w_{f}, plot 222 shows rear tire angular velocity wᵣ, plot 224 shows steering wheel angle δ, plot 226 shows effective front tire radius r_{f}, and plot 228 shows the effective rear tire radius rᵣ. It can be observed that there are some differences at high tire rotation speed, which indicates that there are considerable slip at clutch (see FIG. 14A). Also, the steering wheel angle δ in this case is larger, comparing to the case in FIG. 5. The front tire radius rf also changes during longitudinal acceleration. Similarly, FIGS. 12A-12C show the corresponding outputs measurements for this case. Plot 230 of FIG. 12A shows longitudinal acceleration aₓ of the vehicle, plot 232 of FIG. 12B shows lateral acceleration a_{y} of the vehicle, and plot 234 of FIG. 12C shows yaw rate \dot{ψ} of the vehicle. The state estimation results are similar to that of FIGS. 7A-7B, and therefore they are omitted here.

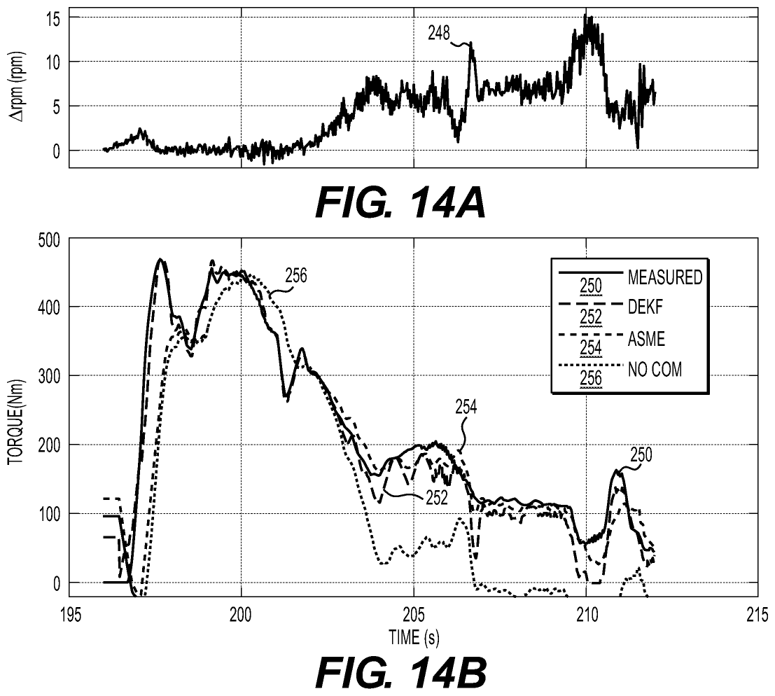

FIG. 13 provides the estimated longitudinal and lateral stiffness. Plot 240 shows the front tire longitudinal stiffness C_{f}^{x}, plot 242 shows the rear tire longitudinal stiffness Cᵣ^{x}, plot 244 shows the front tire lateral stiffness C_{f}^{y}, and plot 246 shows the rear tire lateral stiffnes Cᵣ^{y}. Note that under this slip clutch condition, the longitudinal stiffness converges to different values than the first overtaken clutch case; see FIG. 8, and the lateral stiffness are also changed during vehicle operation. These increased changes could be attributed to larger steering angle since it indicates that the tire have more deformation in the lateral direction, and due to increased difficulty to deform, the lateral stiffness increases.

FIGS. 14A-14B present the torque estimation under this condition. Plot 248 of FIG. 14A shows clutch differential speed (Δrpm). Plot 250 of FIG. 14B, with legend ‘Measured’ is obtained from the torque sensor measurement. Plot 252 of FIG. 14B, with legend ‘DEKF’ is from the proposed DEKF algorithm with clutch slip-speed compensation using equation (10). Plot 254 of FIG. 14B, with legend ‘ASME’ is associated with the algorithm of presented in the article “Transfer case clutch torque modeling and validation under slip and overtaken conditions,” ASME Journal of Dynamic System, Measurement and Control, 2020 with slip-speed compensation, which is based on a pure vehicle dynamics model. Plot 256 of FIG. 14B, with legend ‘No Com’ means the ‘ASME’ approach without clutch slip-speed compensation. For this data set, both clutch overtaken and slip operations are presented; see FIG. 14A for clutch Δrpm. It is observed that under overtaken condition (before 202 seconds), all estimation results presented matches with the measured torque. However, when the clutch starts to slip (202 s -210 s), as shown in FIG. 14B, ‘No Com’ method (without clutch slip-speed compensation) was not able to track the measured torque, whereas both ‘DEKF’ and ‘ASME’ approaches are close to the measured one.

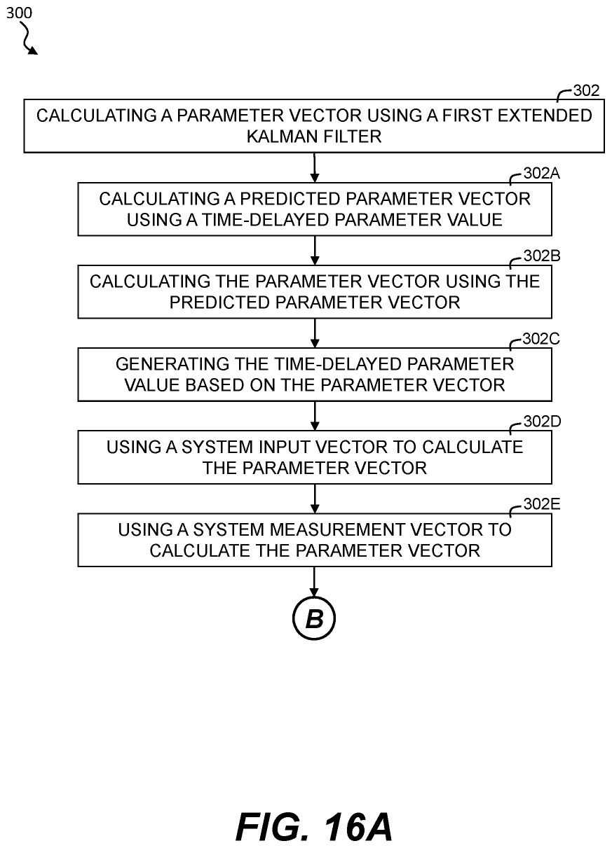

The second slip clutch case torque estimation validation is presented in FIGS. 15A-15B. Plot 258 of FIG. 15A shows clutch differential speed (Δrpm). Plot 260 of FIG. 15B, with legend ‘Measured’ is obtained from the torque sensor measurement. Plot 262 of FIG. 15B, with legend ‘DEKF’ is from the proposed DEKF algorithm with clutch slip-speed compensation using equation (10). Plot 264 of FIG. 15B, with legend ‘ASME’ is associated with the algorithm of presented in the article “Transfer case clutch torque modeling and validation under slip and overtaken conditions,” ASME Journal of Dynamic System, Measurement and Control, 2020 with slip-speed compensation, which is based on a pure vehicle dynamics model. Plot 266 of FIG. 15B, with legend ‘No Com’ means the ‘ASME’ approach without clutch slip-speed compensation. In this data set, the steering angle is relatively small, and the parameter convergence is similar to the case in FIG. 8. The estimated traction torque matches the measured torque in a similar way for both ‘DEKF’ and ‘ASME’ approaches, while the ‘No Com’ approach (without slip-speed compensation) cannot accurately estimate the measured torque.

### D. Torque Estimation Performance Evaluation

With the traction torque estimation results under both clutch overtaken and slip conditions presented in the last two subsections, the numerical error analysis are performed and subsequently comparison are made in this subsection.

To perform the numerical error analysis, two performance indexes are defined. The first one is Absolute Mean Square Error (AMSE), which is defined in equation (24), below:

$$A M S E = \sqrt{\frac{1}{{n}_{d}} {\sum }_{{n}_{q} = 1}^{{n}_{d}} ( {( \vert {T}_{fe} - {T}_{mea} \vert )}^{2} )} , \qquad ( 24 )$$

and the second index is Relative Mean Square Error (RMSE), which is defined in equation (25), below:

$$R M S E = \sqrt{\frac{1}{{n}_{d}} {\sum }_{{n}_{q} = 1}^{{n}_{d}} ( {( \frac{\vert {T}_{fe} - {T}_{mea} \vert}{{T}_{mea}} )}^{2} )} \qquad ( 25 )$$

where T_{fe} means the estimated traction torque; Tₘₑₐ means the measured traction torque; and n_{d} is the total number of active data points, where only acceleration duration accounts for active data.

The error performance results are shown in Table I. It can be observed that for overtaken cases, both AMSE and RMSE of the ‘DEKF’ algorithm performs much better than the ‘ASME’ approach. More specifically, for overtaken Second case, the AMSE improves by 20 Nm (from 27.5 Nm to 7.16 Nm) and the RMSE reduces by 12%. For the first slip clutch condition case, the AMSE of ‘DEKF’ improves by 9 Nm compared to ‘ASME’ approach while the RMSE performs almost the same (9.67% and 9.37%, respectively). And for the second slip case, both AMSE and RMSE of the ‘DEKF’ algorithm outperform the ‘ASME’ approach with significant improvement (around 40 Nm for AMSE and 6% for RMSE). Note that the ‘No Com’ approach cannot track the measured torque under clutch slip condition.

TABLE I
Torque estimation error summary

| Data sets | Approach | AMSE (Nm) | RMSE (%) |
|---|---|---|---|
| Overtaken | DEKF | 12.6 | 5.95 |
| Case 1 | ASME | 28.7 | 14.7 |
| | No Com | 28.7 | 14.7 |
| Overtaken | DEKF | 7.16 | 4.73 |
| Case 2 | ASME | 27.5 | 16.5 |
| | No Com | 27.5 | 16.5 |
| Slip | DEKF | 15.3 | 9.67 |
| Case 1 | ASME | 24.6 | 9.37 |
| | No Com | 94.4 | 65.5 |
| Slip | DEKF | 23.6 | 11.1 |
| Case 2 | ASME | 63.0 | 17.3 |
| | No Com | 91.6 | 38.0 |

### VI. Conclusion

The present disclosure presents methods for utilizing a Dual Extended Kalman Filter algorithm to estimate the 4-Wheel-Drive (4WD) vehicle traction torque as well as vehicle states and parameters in real-time under various vehicle operational conditions. Specially, the front tire dynamic and full 4WD vehicle dynamic models, considering the longitudinal, lateral, and yaw direction motions, are first established. The traction torque estimation problem is then converted to the estimation of vehicle states and parameters. The simultaneous state and parameter estimation problem can be solved using the Dual Extended Kalman Filter algorithm with a recursive estimation solution that is real-time implementable. The effectiveness of the proposed algorithm is confirmed by comparing the estimated traction torque to experimental measurements as well as existing approaches. Under clutch overtaken condition, the AMSE (Absolute Mean Square Error) improves by 20 Nm and the RMSE (Relative Mean Square Error) reduces by 12%; while under clutch slip condition, the AMSE improves by 40 Nm and the RMSE reduces by 6%. Future work includes validation of the proposed algorithm in a hardware-in-the-loop simulation environment.

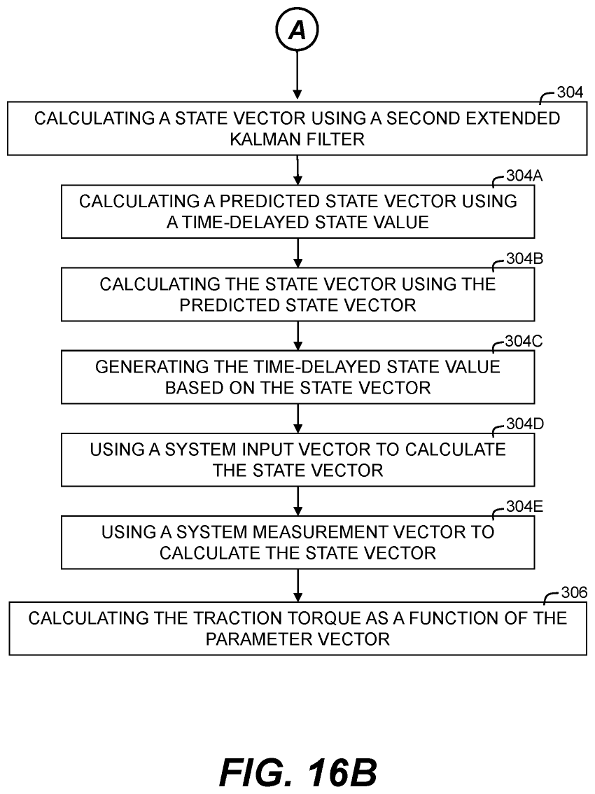

A method 300 of estimating longitudinal stiffness to calculate a traction torque of a tire of a vehicle is shown in the flow chart of FIGS. 16A-16B. The method 300 includes calculating a parameter vector using a first extended Kalman filter at step 302. For example, the machine-readable storage medium 64 storing instructions that, when executed by the processor 62, cause the processor to calculate the parameter vector using a first extended Kalman filter.

In some embodiments step 302 includes calculating a predicted parameter vector using a time-delayed parameter value at sub-step 302A. For example, sub-step 302A may include calculating the predicted parameter vector based on the time-delayed parameter value. In some embodiments step 302 also includes calculating the parameter vector using the predicted parameter vector at sub-step 302B. For example, sub-step 302B may include calculating the parameter vector based on the predicted parameter vector. In some embodiments step 302 also includes generating the time-delayed parameter value based on the parameter vector at sub-step 302C.

In some embodiments step 302 further includes: using a system input vector to calculate the parameter vector at sub-step 302D. For example, sub-step 302D may include calculating the parameter vector based on the system input vector. The system input vector may include one or more of: an angular velocity of a front tire, an angular velocity of a rear tire, a steering wheel angle, an effective tire radius of the front tire, or an effective tire radius of the rear tire. In some embodiments, the system input vector may include each of: the angular velocity of a front tire, the angular velocity of a rear tire, the steering wheel angle, the effective tire radius of the front tire, and the effective tire radius of the rear tire.

In some embodiments step 302 further includes: using a system measurement vector to calculate the parameter vector at sub-step 302E. For example, sub-step 302E may include calculating the parameter vector based on the system measurement vector. The system measurement vector may include one or more of: a longitudinal acceleration of the vehicle, a lateral acceleration of the vehicle, or a yaw rate of the vehicle. In some embodiments, the system measurement vector may include may include each of: the longitudinal acceleration of the vehicle, the lateral acceleration of the vehicle, and the yaw rate of the vehicle.

The method 300 also includes calculating a state vector using a second extended Kalman filter at step 304. For example, the machine-readable storage medium 64 storing instructions that, when executed by the processor 62, cause the processor to calculate the state vector using a second extended Kalman filter.

In some embodiments step 304 includes calculating a predicted state vector using a time-delayed state value at sub-step 304A. For example, sub-step 304A may include calculating the predicted state vector based on the time-delayed state value. In some embodiments step 304 further includes calculating the state vector using the predicted state vector at sub-step 304B. For example, sub-step 304B may include calculating the state vector based on the predicted state value. In some embodiments step 304 further includes generating the time-delayed state value based on the state vector at sub-step 304C.

In some embodiments step 304 further includes: using a system input vector to calculate the state vector at sub-step 304D. For example, sub-step 304D may include calculating the state vector based on the system input vector. The system input vector may include least one of: an angular velocity of a front tire, an angular velocity of a rear tire, a steering wheel angle, an effective tire radius of the front tire, or an effective tire radius of the rear tire. In some embodiments, the system input vector may include may include each of: the angular velocity of a front tire, the angular velocity of a rear tire, the steering wheel angle, the effective tire radius of the front tire, and the effective tire radius of the rear tire.

In some embodiments step 304 further includes using a system measurement vector to calculate the state vector at sub-step 304E. For example, sub-step 304E may include calculating the state vector based on the system measurement vector. The system measurement vector may include at least one of: a longitudinal acceleration of the vehicle, a lateral acceleration of the vehicle, or a yaw rate of the vehicle. In some embodiments, the system measurement vector may include may include each of: the longitudinal acceleration of the vehicle, the lateral acceleration of the vehicle, and the yaw rate of the vehicle.

The method 300 also includes calculating the traction torque as a function of the parameter vector and the state vector at step 306. For example, the machine-readable storage medium 64 storing instructions that, when executed by the processor 62, cause the processor to calculate the traction torque as a function of the parameter vector and the state vector.

The present disclosure provides a method of calculating a longitudinal stiffness Cᵢ^{x} of a tire of a vehicle. The method includes calculating a parameter vector x_{c,k}^{p} using a first extended Kalman filter 102. The first extended Kalman filter 102 may be implemented as software instructions being executed by the processor 62. The first extended Kalman filter 102 may take other forms, such as dedicated hardware or a combination of hardware and software. The method also includes calculating a state vector x_{c,k}^{s} using a second extended Kalman filter 104. The method also includes calculating the longitudinal stiffness Cᵢ^{x} as a function of the parameter vector x_{c,k}^{p} and the state vector x_{c,k}^{s}. This calculation of the longitudinal stiffness Cᵢ^{x} may be performed by the processor 62 or by other hardware and/or software.

According to an aspect of the disclosure, calculating the parameter vector x_{c,k}^{p} using the first extended filter Kalman 102 may further comprise: calculating a predicted parameter vector x_{p,k}^{p} using a time-delayed parameter value x_{c,k-1}^{p}. The parameter prediction block 110 of the first extended Kalman filter 102 may perform this calculation of the predicted parameter vector x_{p,k}^{p}. Calculating the parameter vector x_{c,k}^{p} using the first extended Kalman filter 102 may also comprise: calculating the parameter vector x_{c,k}^{p} using the predicted parameter vector x_{p,k}^{p}. The parameter correction block 140 of the first extended Kalman filter 102 may perform this calculation of the parameter vector x_{c,k}^{p}. Calculating the parameter vector x_{c,k}^{p} using the first extended filter Kalman 102 may also comprise: generating the time-delayed parameter value x_{c,k-1}^{p} based on the parameter vector x_{c,k}^{p}. The first time delay block 112 of the first extended Kalman filter 102 may generate the time-delayed parameter value x_{c,k-1}^{p}.

According to an aspect of the disclosure, calculating the parameter vector x_{c,k}^{p} may further comprise using a system input vector uₖ to calculate the parameter vector x_{c,k}^{p}. The system input vector uₖ may comprise at least one of: an angular velocity of a front tire w_{f}, an angular velocity of a rear tire wᵣ, a steering wheel angle δ, an effective tire radius of the front tire r_{f}, or an effective tire radius of the rear tire rᵣ. In some embodiments, the system input vector uₖ comprises each of: the angular velocity of a front tire w_{f}, the angular velocity of a rear tire wᵣ, the steering wheel angle δ, the effective tire radius of the front tire r_{f}, and the effective tire radius of the rear tire rᵣ.

According to an aspect of the disclosure, calculating the parameter vector x_{c,k}^{p} may further comprise using a system measurement vector yₖ to calculate the parameter vector x_{c,k}^{p}, the system measurement vector yₖ may comprise at least one of: a longitudinal acceleration aₓ of the vehicle, a lateral acceleration a_{y} of the vehicle, or a yaw rate \dot{ψ} of the vehicle. In some embodiments, the system measurement vector yₖ comprises each of: the longitudinal acceleration aₓ of the vehicle, the lateral acceleration a_{y} of the vehicle, and the yaw rate \dot{ψ} of the vehicle.

According to an aspect of the disclosure, calculating the state vector x_{c,k}^{s} using the second extended Kalman filter 104 may further comprise: calculating a predicted state vector x_{p,k}^{s} using a time-delayed state value x_{c,k-1}^{s}. The state prediction block 120 of the second extended Kalman filter 104 may perform this calculation of the predicted state vector x_{p,k}^{s}. Calculating the state vector x_{c,k}^{s} using the second extended Kalman filter 104 may also comprise: calculating the state vector x_{c,k}^{s} using the predicted state vector x_{p,k}^{s}. The state correction block 130 of the second extended Kalman filter 104 may perform this calculation of the state vector x_{c,k}^{s}. Calculating the state vector x_{c,k}^{s} using the second extended filter Kalman 104 may also comprise: generating the time-delayed state value x_{c,k-1}^{s} based on the state vector x_{c,k}^{s}. The second time delay block 122 of the second extended Kalman filter 122 may generate the time-delayed state value x_{c,k-1}^{s}.

According to an aspect of the disclosure, calculating the state vector x_{c,k}^{s} may further comprise using a system input vector uₖ to calculate the state vector x_{c,k}^{s}. The system input vector uₖ may comprise at least one of: an angular velocity of a front tire w_{f}, an angular velocity of a rear tire wᵣ, a steering wheel angle δ, an effective tire radius of the front tire r_{f}, or an effective tire radius of the rear tire rᵣ. In some embodiments, the system input vector uₖ comprises each of: the angular velocity of a front tire w_{f}, the angular velocity of a rear tire wᵣ, the steering wheel angle δ, the effective tire radius of the front tire r_{f}, and the effective tire radius of the rear tire rᵣ.

According to an aspect of the disclosure, calculating the state vector x_{c,k}^{s} may further comprise using a system measurement vector yₖ to calculate the state vector x_{c,k}^{s}, the system measurement vector yₖ may comprise at least one of: a longitudinal acceleration ax of the vehicle, a lateral acceleration a_{y} of the vehicle, or a yaw rate \dot{ψ} of the vehicle. In some embodiments, the system measurement vector yₖ comprises each of: the longitudinal acceleration aₓ of the vehicle, the lateral acceleration a_{y} of the vehicle, and the yaw rate \dot{ψ} of the vehicle.

The present disclosure provides a method of calculating a longitudinal stiffness Cᵢ^{x} of a tire of a vehicle. The method includes calculating a parameter vector x_{c,k}^{p} using a first extended Kalman filter 102. The first extended Kalman filter 102 may be implemented as software instructions being executed by the processor 62. The first extended Kalman filter 102 may take other forms, such as dedicated hardware or a combination of hardware and software. The method also includes calculating a state vector x_{c,k}^{s} using a second extended Kalman filter 104. The method also includes calculating the longitudinal stiffness Cᵢ^{x} as a function of the parameter vector x_{c,k}^{p} and the state vector x_{c,k}^{s}. This calculation of the longitudinal stiffness Cᵢ^{x} may be performed by the processor 62 or by other hardware and/or software.

According to an aspect of the disclosure, a method for computing traction torque of a vehicle is provided. The method may be performed by the processor 62. The method includes computing the longitudinal stiffness Cf of the tire using the first and second Kalman filters 102, 104, as set forth above; and computing the traction torque as a function of the longitudinal stiffness C_{f}^{x} of the tire and a linear speed difference between a tire speed rᵢwᵢ of the tire and a vehicle longitudinal speed vₓ.

According to an aspect of the disclosure, a system for calculating traction torque of a tire of a vehicle comprises: a processor 62; and a machine-readable storage medium 64 storing instructions that, when executed by the processor 62, cause the processor to: calculate a parameter vector x_{c,k}^{p} using a first extended Kalman filter 102; calculate a state vector x_{c,k}^{s} using a second extended Kalman filter 104; calculate the longitudinal stiffness C_{f}^{x} of the tire as a function of the parameter vector x_{c,k}^{p} and the state vector x_{c,k}^{s} and calculate the traction torque of the tire based on the longitudinal stiffness C_{f}^{x} of the tire.

The vehicle tire traction torque, as determined by the system and method of the present disclosure, may be used for several different applications in a vehicle. For example, a system of the present disclosure may transmit vehicle tire traction torque to a traction controller, which may take one or more actions based on the vehicle tire traction torque. For example, the traction controller may use torque vectoring and/or limiting the torque output of a prime mover, such as a traction motor and/or internal combustion engine to maintain vehicle tire traction. Additionally or alternatively, the traction controller may use the vehicle tire traction torque for one or more computations or determinations related to controlling torque production and distribution in the vehicle. Additionally or alternatively, the system of the present disclosure may transmit vehicle tire traction torque to a powertrain controller, which may take one or more corrective actions based on the vehicle tire traction torque. For example, the powertrain controller may determine a powertrain operating mode, such as two-wheel drive, all-wheel drive, and/or four-wheel drive based on the vehicle tire traction torque.

The system, methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or alternatively, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices as well as heterogeneous combinations of processors processor architectures, or combinations of different hardware and software, or any other machine capable of executing program instructions.

Thus, in one aspect, each method described above and combinations thereof may be embodied in computer executable code that, when executing on one or more computing devices performs the steps thereof In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

The foregoing description is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A method of estimating longitudinal stiffness to calculate a traction torque of a tire of a vehicle, comprising:
calculating a parameter vector using a first extended Kalman filter;
calculating a state vector using a second extended Kalman filter; and
calculating the traction torque as a function of the parameter vector and the state vector,
wherein calculating the parameter vector using the first extended Kalman filter further comprises:
calculating a predicted parameter vector using a time-delayed parameter value;
calculating the parameter vector using the predicted parameter vector; and
generating the time-delayed parameter value based on the parameter vector.

2. (canceled)

3. The method of claim 1, wherein calculating the parameter vector further comprises using a system input vector to calculate the parameter vector, the system input vector comprising at least one of: an angular velocity of a front tire, an angular velocity of a rear tire, a steering wheel angle, an effective tire radius of the front tire, or an effective tire radius of the rear tire.

4. The method of claim 3, wherein the system input vector comprises each of: the angular velocity of a front tire, the angular velocity of a rear tire, the steering wheel angle, the effective tire radius of the front tire, and the effective tire radius of the rear tire.

5. The method of claim 1, wherein calculating the parameter vector further comprises using a system measurement vector to calculate the parameter vector, the system measurement vector comprising at least one of: a longitudinal acceleration of the vehicle, a lateral acceleration of the vehicle, or a yaw rate of the vehicle.

6. The method of claim 5, wherein the system measurement vector comprises each of: the longitudinal acceleration of the vehicle, the lateral acceleration of the vehicle, and the yaw rate of the vehicle.

7. A method of estimating longitudinal stiffness to calculate a traction torque of a tire of a vehicle, comprising:
calculating a parameter vector using a first extended Kalman filter;
calculating a state vector using a second extended Kalman filter; and
calculating the traction torque as a function of the parameter vector and the state vector,
wherein calculating the state vector using the second extended Kalman filter further comprises:
calculating a predicted state vector using a time-delayed state value;
calculating the state vector using the predicted state vector; and
generating the time-delayed state value based on the state vector.

8. The method of claim 7, wherein calculating the state vector further comprises using a system input vector to calculate the state vector, the system input vector comprising at least one of: an angular velocity of a front tire, an angular velocity of a rear tire, a steering wheel angle, an effective tire radius of the front tire, or an effective tire radius of the rear tire.

9. The method of claim 8, wherein the system input vector comprises each of: the angular velocity of a front tire, the angular velocity of a rear tire, the steering wheel angle, the effective tire radius of the front tire, and the effective tire radius of the rear tire.

10. The method of claim 7, wherein calculating the state vector further comprises using a system measurement vector to calculate the state vector, the system measurement vector comprising at least one of: a longitudinal acceleration of the vehicle, a lateral acceleration of the vehicle, or a yaw rate of the vehicle.

11. The method of claim 10, wherein the system measurement vector comprises each of: the longitudinal acceleration of the vehicle, the lateral acceleration of the vehicle, and the yaw rate of the vehicle.

12. A system for calculating traction torque of a tire of a vehicle, comprising:
a processor; and
a machine-readable storage medium storing instructions that, when executed by the processor, cause the processor to:
calculate a parameter vector using a first extended Kalman filter;
calculate a state vector using a second extended Kalman filter;
calculate a longitudinal stiffness of the tire as a function of the parameter vector and the state vector; and
calculate the traction torque of the tire based on the longitudinal stiffness of the tire s
wherein calculating the parameter vector using the first extended Kalman filter further comprises:
calculating a predicted parameter vector using a time-delayed parameter value;
calculating the parameter vector using the predicted parameter vector; and
generating the time-delayed parameter value based on the parameter vector.

13. (canceled)

14. The system of claim 12, wherein calculating the parameter vector further comprises using a system input vector to calculate the parameter vector, the system input vector comprising at least one of: an angular velocity of a front tire, an angular velocity of a rear tire, a steering wheel angle, an effective tire radius of the front tire, or an effective tire radius of the rear tire.

15. The system of claim 12, wherein calculating the parameter vector further comprises using a system measurement vector to calculate the parameter vector, the system measurement vector comprising at least one of: a longitudinal acceleration of the vehicle, a lateral acceleration of the vehicle, or a yaw rate of the vehicle.

16. The system of claim 14, wherein the system input vector comprises each of: the angular velocity of a front tire, the angular velocity of a rear tire, the steering wheel angle, the effective tire radius of the front tire, and the effective tire radius of the rear tire.

17. The system of claim 15, wherein the system measurement vector comprises each of: the longitudinal acceleration of the vehicle, the lateral acceleration of the vehicle, and the yaw rate of the vehicle.

18. The system of claim 12, wherein calculating the state vector using the second extended Kalman filter further comprises:
calculating a predicted state vector using a time-delayed state value;
calculating the state vector using the predicted state vector; and
generating the time-delayed state value based on the state vector.

19. The system of claim 18, wherein calculating the state vector further comprises using a system input vector to calculate the state vector, the system input vector comprising at least one of: an angular velocity of a front tire, an angular velocity of a rear tire, a steering wheel angle, an effective tire radius of the front tire, or an effective tire radius of the rear tire.

20. The system of claim 19, wherein the system input vector comprises each of: the angular velocity of a front tire, the angular velocity of a rear tire, the steering wheel angle, the effective tire radius of the front tire, and the effective tire radius of the rear tire.

21. The system of claim 18, wherein calculating the state vector further comprises using a system measurement vector to calculate the state vector, the system measurement vector comprising at least one of: a longitudinal acceleration of the vehicle, a lateral acceleration of the vehicle, or a yaw rate of the vehicle.

22. The system of claim 21, wherein the system measurement vector comprises each of: the longitudinal acceleration of the vehicle, the lateral acceleration of the vehicle, and the yaw rate of the vehicle.
